(19) United States
(12) Patent Application Publication
(10) Pub. No.: US 2026/0163157 A1
(43) Pub. Date: Jun. 11, 2026

(54) ENCLOSURE FOR A BATTERY SYSTEM

(71) Applicant: Caterpillar Inc., Peoria, IL (US)

(72) Inventors: Paul Alan Kemble, Leicestershire (GB); Colin Haag, Columbus, OH (US); Sam Mervyn Millington, Newport (GB); Robert W Sweney, Oakland, CA (US); Jeffrey Giewai Wong, Cotati, CA (US)

(73) Assignee: Caterpillar Inc., Peoria, IL (US)

(21) Appl. No.: 18/971,212

(22) Filed: Dec. 6, 2024

(51) Int. Cl. H01M 50/256; H01M 50/204; H01M 50/244; H01M 50/262

(52) U.S. Cl. CPC H01M 50/256; H01M 50/204; H01M 50/244; H01M 50/262

(57) ABSTRACT

An enclosure, for a battery system, includes first and second casing members, and a pin. The first casing member defines a first base wall, and first sidewalls defining a first mating surface. The first casing member includes a pocket surface defined between the first mating surface and the first base wall, and a first bore extending between the pocket surface and the first base wall. The second casing member defines a second base wall, and second sidewalls defining a second mating surface. The second casing member includes a second bore. The pin is received within the first bore and the second bore facilitating alignment and engagement of the first and second mating surfaces to define a closed volume for energy-storage-cells of the battery system. When the first and second casing members are assembled, the pocket surface provides access to a portion of the pin for lifting purposes.

### TECHNICAL FIELD

The present disclosure relates to battery systems. More particularly, the present disclosure relates to a battery system enclosure for housing energy storage cells and a method of assembling the battery system enclosure.

### BACKGROUND

Battery systems (e.g., battery packs, or battery modules) are widely used in various applications, such as vehicles, equipment, and machinery, to store and provide electrical energy. A typical battery system may include one or more energy storage cells housed in a sealed volume defined by a battery housing. Said battery housing may generally be formed from two casing members that, when assembled, enclose, and protect the battery cells.

During an assembly of these two casing members to form the battery housing, misalignment of the two casing members may result in an inadequate seal connection between the two casing members, leading to issues such as leakage, reduced efficiency, or failure of the battery system. Furthermore, once assembled, these battery systems often need to be lifted and moved between different locations or orientations, such as during installation or removal from a vehicle for servicing. However, implementation of a built-in lifting provisions in the battery housing may require material and/or external features to be added to the battery housing, thereby increasing weight and size of the battery system.

Chinese Application Publication No. 108511659 discloses a 21700 cell series-parallel battery module. The 21700 cell series-parallel battery module includes a plurality of 21700 battery module units arranged in sequence. Each 21700 battery module unit includes a module housing, a plurality of 21700 single cells, parallel confluence plates mounted on two outer walls of the module housing, and a plurality of insertion slots, electrode insertion through holes, and a plurality of positioning columns provided in two inner walls of the module housing.

### SUMMARY OF THE INVENTION

In one aspect, the disclosure relates to an enclosure for a battery system. The enclosure includes a first casing member, a second casing member, and a pin. The first casing member defines a first base wall and a plurality of first sidewalls extending from the first base wall along a first axis to define a first mating surface spaced from the first base wall. The first casing member includes a pocket surface and a first bore. The pocket surface is defined between the first mating surface and the first base wall. The first bore extends between the pocket surface and the first base wall along the first axis. Further, the second casing member defines a second base wall and a plurality of second sidewalls extending from the second base wall along a second axis to define a second mating surface spaced from the second base wall. The second casing member includes a second bore. The pin is slidably received within the first bore and the second bore. The pin is configured to facilitate alignment and engagement of the first mating surface with the second mating surface to define a closed volume of the battery system when the first casing member and the second casing member are assembled together. When the first casing member and the second casing member are assembled together, the pocket surface provides access to a portion of the pin extending between the pocket surface and the second mating surface.

In another aspect, the disclosure is directed to a battery system. The battery system includes one or more energy storage cells and an enclosure for accommodating the one or more energy storage cells. The enclosure includes a first casing member, a second casing member, and a pin. The first casing member defines a first base wall and a plurality of first sidewalls extending from the first base wall along a first axis to define a first mating surface spaced from the first base wall. The first casing member includes a pocket surface and a first bore. The pocket surface is defined between the first mating surface and the first base wall. The first bore extends between the pocket surface and the first base wall along the first axis. Further, the second casing member defines a second base wall and a plurality of second sidewalls extending from the second base wall along a second axis to define a second mating surface spaced from the second base wall. The second casing member includes a second bore. The pin is slidably received within the first bore and the second bore. The pin is configured to facilitate alignment and engagement of the first mating surface with the second mating surface to define a closed volume of the battery system when the first casing member and the second casing member are assembled together. When the first casing member and the second casing member are assembled together, the pocket surface provides access to a portion of the pin extending between the pocket surface and the second mating surface.

In yet another aspect, the disclosure relates to a method of assembling an enclosure of a battery system. The method includes using a first casing member of the enclosure. The first casing member defines a first base wall and a plurality of first sidewalls extending from the first base wall along a first axis to define a first mating surface spaced from the first base wall. The first casing member including a pocket surface and a first bore. The pocket surface is defined between the first mating surface and the first base wall. The first bore extends between the pocket surface and the first base wall. The method further includes inserting a first end portion of a pin within the first bore. Further, the method includes inserting using a second casing member of the enclosure. The second casing member defines a second base wall and a plurality of second sidewalls extending from the second base wall along a second axis to define a second mating surface spaced from the second base wall. The second casing member includes a second bore. Furthermore, the method includes causing a second end portion of the pin to be inserted within the second bore to facilitate alignment and engagement of the first mating surface and the second mating surface to define a closed volume of the battery system when the first casing member and the second casing member are assembled together. When the first casing member and the second casing member are assembled together, the pocket surface provides access to a portion of the pin extending between the pocket surface and the second mating surface.

### BRIEF DESCRIPTION OF THE DRAWINGS

FIG. 1 illustrates a battery system including an enclosure and energy storage cells accommodated within the enclosure, in accordance with an embodiment of the present disclosure;

FIG. 2 is an exploded view of the enclosure, in accordance with an embodiment of the present disclosure;

FIG. 3 is a top view of a first casing member of the enclosure, in accordance with an embodiment of the present disclosure;

FIG. 4 is a top view of a second casing member of the enclosure, in accordance with an embodiment of the present disclosure;

FIG. 5 is a cross-sectional view of a portion of the enclosure, in accordance with an embodiment of the present disclosure;

FIG. 6 illustrates the enclosure in a disassembled state, in accordance with an embodiment of the present disclosure; and

FIG. 7 illustrates the enclosure, in an assembled state, engaged with a lifting mechanism, in accordance with an embodiment of the present disclosure; and

FIG. 8 is a flowchart illustrating a method of assembling the enclosure of the battery system, in accordance with an embodiment of the present disclosure.

### DETAILED DESCRIPTION

Reference will now be made in detail to specific embodiments or features, examples of which are illustrated in the accompanying drawings. Generally, corresponding reference numbers may be used throughout the drawings to refer to the same or corresponding parts, e.g., 1, 1′, 1″, 101 and 201 could refer to one or more comparable components used in the same and/or different depicted embodiments.

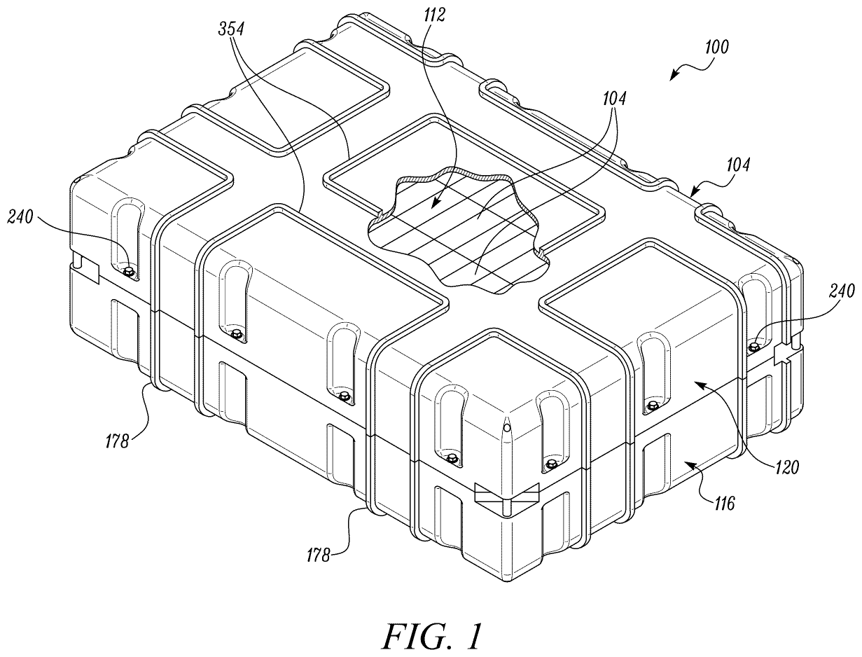

Referring to FIG. 1, a battery system 100 is illustrated. The battery system 100 is a battery pack (or a battery module) that may be installed on mobile machines, such as wheel loaders, off-highway trucks, excavators, compactors, and the like, or may be installed on stationary machines, such as generator sets, containerized power modules. The battery system 100 is used to store and supply electrical energy to power operations of the mobile machines and/or the stationary machines.

The battery system 100 includes energy storage cells 104 and an enclosure 108. The battery system 100 may also include electrical and/or electronic components, such as busbars, a battery management system, and the like. It should be noted that construction and functionality of such electrical and/or electronic components are known in the art, and therefore, they are not discussed.

The energy storage cells 104 may be lithium-ion battery cells. Examples of the energy storage cells 104 may include, but need not be limited to, a lithium-ion cell, such as, a lithium cobalt oxide cell, a lithium manganese oxide cell, a lithium nickel manganese cobalt oxide cell, a lithium iron phosphate cell, a lithium nickel cobalt aluminum oxide cell, and a lithium titanate cell. In some embodiments, the energy storage cells 104 may be a prismatic cell. Alternatively, in another embodiment, the energy storage cell 104 may be a pouch cell. In yet another embodiment, the energy storage cell 104 may be a cylindrical cell. The energy storage cells 104 may be disposed in a closed volume 112 of the enclosure 108. In an example, the energy storage cells 104 may be disposed side-by-side in a row or a column (i.e., collectively referred to as a stack) within the closed volume 112 of the enclosure 108.

The enclosure 108 is configured to sealably secure and protect the energy storage cells 104 from external contaminants like debris, dirt, and dust. In addition, the enclosure 108 is configured to be lifted and moved between different locations or orientations, such as during installation or removal from a battery pack (installed on a machine) for servicing. The enclosure 108 includes a first casing member 116, a second casing member 120, and at least one pin 124. In addition, the enclosure 108 may include a sealing member 128. Each of the first casing member 116, the second casing member 120, the at least one pin 124, and the sealing member 128 is now discussed in detail.

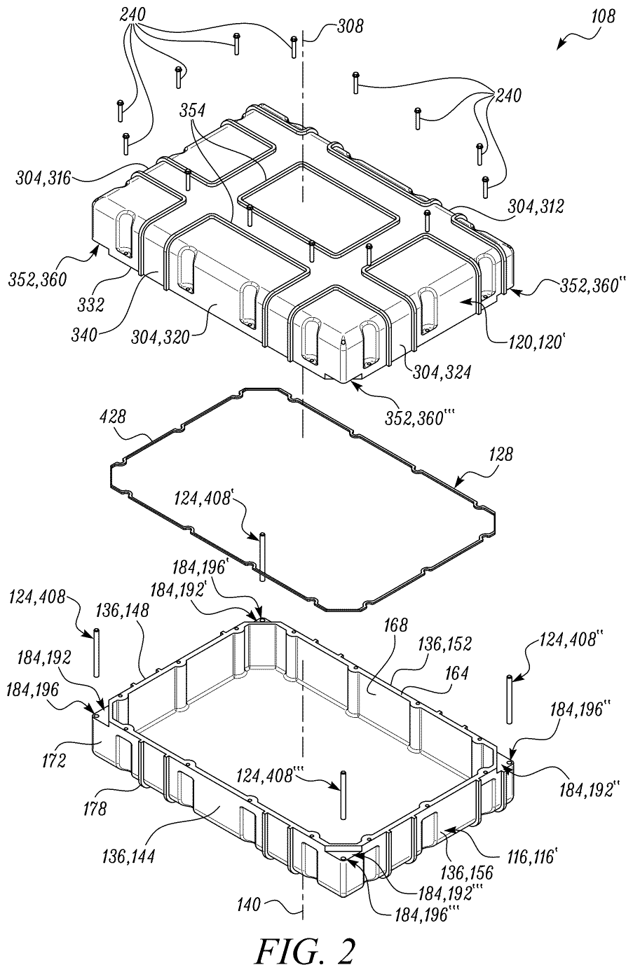

Referring to FIG. 2, the first casing member 116 defines a first base wall 132 and a plurality of first sidewalls 136 that extend from the first base wall 132 along a first axis 140 of the first casing member 116. By way of non-limiting example, the first casing member 116 may be embodied as a substantially hollow cuboid shaped structure 116′ with one opened wall. In an exemplary embodiment, as shown in FIG. 2, the first casing member 116 defines four first sidewalls 136, namely—a first wall 144, a second wall 148, a third wall 152, and a fourth wall 156. The first wall 144 and the third wall 152 may be disposed perpendicular to the first base wall 132. Also, the first wall 144 and the third wall 152 may be disposed parallel to and spaced apart from each other. Further, the second wall 148 and the fourth wall 156 may be disposed parallel to and spaced apart from each other. Also, the second wall 148 and the fourth wall 156 may be disposed perpendicular to the first base wall 132, and the first wall 144 and the third wall 152. The first base wall 132, the first wall 144, the second wall 148, the third wall 152, and the fourth wall 156 combinedly define a first portion 160 of the closed volume 112 of the enclosure 108.

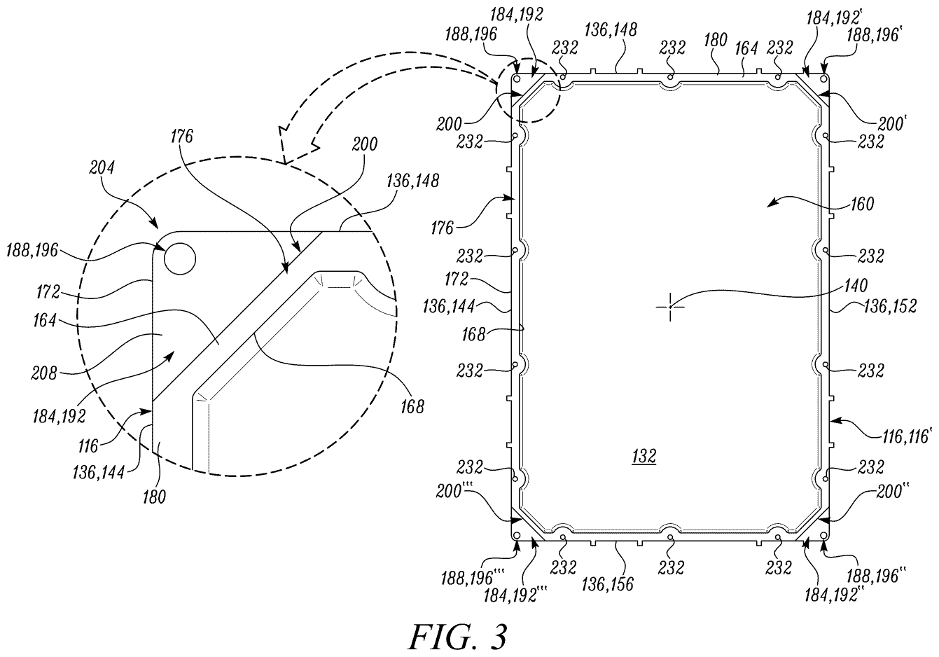

The first sidewalls 136 extend outwardly from the first base wall 132, along the first axis 140, to define a first mating surface 164 spaced from the first base wall 132. In an example, as shown in FIG. 3, the first sidewalls 136 define an internal surface 168 (or internal periphery 168) extending around the first portion 160 (of the closed volume 112) and an external surface 172 (or external periphery 172) extending around the internal surface 168 to define the first mating surface 164. The first mating surface 164 may define an annular path 176 (hereinafter referred to as “first annular path 176”) surrounding the first portion 160 (of the closed volume 112), and an end face 180 (hereinafter referred to as “first end face 180”) extending along the first annular path 176. The first end face 180 may be a planar surface. Further, as shown in FIG. 2, multiple rails 178 are defined at the first base wall 132 and the first sidewalls 136. The rails 178 may provide additional strength to the first casing member 116, and may also facilitate in mounting and/or arranging the battery system 100 onto an installation structure for example, battery racks of a machine.

Further, the first casing member 116 includes one or more pocket surfaces 184 (hereinafter referred to as “first pocket surface 184”) and corresponding one or more first bores 188. In an exemplary embodiment, as shown in FIGS. 2 and 3, the first casing member 116 includes four first pocket surfaces 184, namely—the first pocket surfaces 192, 192′,192″, 192″′, and corresponding four first bores 188, namely—the first bores 196, 196′, 196″, 196″′. It may be contemplated that, in other embodiments, the first casing member 116 may include a lower or a higher number of the pocket surfaces and the first bores.

The first pocket surface 192 may be a planar surface. The first pocket surface 192 may be parallel to the first mating surface 164. In addition, the first pocket surface 192 may be parallel to the first base wall 132. The first pocket surface 192 is defined between the first mating surface 164 and the first base wall 132. In an example, as shown in FIGS. 2 and 3, the first casing member 116 includes a pocket 200 defined in the external surface 172 (or the external periphery 172) of the at least one first sidewall 136, for example, at a junction 204 of two adjacent first sidewalls 136, i.e., the first wall 144 and the second wall 148. In the present configuration, the pocket 200 extends from the first mating surface 164 towards the first base wall 132 (along the first axis 140) to define a shoulder portion 208 that, in turn, defines the first pocket surface 192. It should be noted that the first pocket surfaces 192′, 192″, 192″′ may be defined in a similar manner, as described above, by their respective pockets 200′, 200″, 200″′, and therefore are not discussed in detail for brevity.

The first bores 196, 196′, 196″, 196″′ may extend between their corresponding first pocket surfaces 192, 192′, 192″, 192″′ and the first base wall 132. For example, as shown in FIGS. 2 and 3, the first bore 196 may extend between the first pocket surface 192 and the first base wall 132, the first bore 196′ may extend between the corresponding first pocket surface 192′ and the first base wall 132, the first bore 196″ may extend between the corresponding first pocket surface 192″ and the first base wall 132, and the first bore 196″′ may extend between the corresponding first pocket surface 192″′ and the first base wall 132.

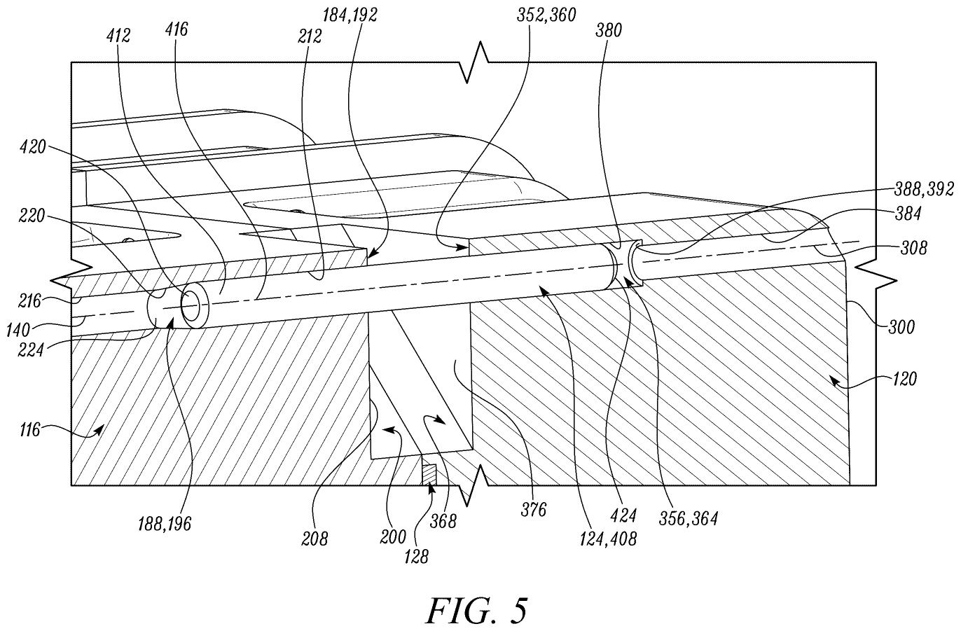

For explanatory purposes, the first bore 196 will now be explained in detail with reference to FIG. 5. However, it should be noted that the description provided below for the first bore 196 may be equally applicable to the other first bores 196′, 196″, 196″′ corresponding to their respective first pocket surfaces 192′, 192″, 192″′, without any limitations.

The first bore 196 may define a first section 212, a second section 216, and a third section 220. The first section 212 may have a first diameter. The first section 212 may extend from the corresponding first pocket surface 192 towards the first base wall 132 in a first direction along the first axis 140. The second section 216 may have a second diameter lower than the first diameter of the first section 212. The second section 216 may extend from the first base wall 132 towards the corresponding first pocket surface 192 in a second direction (opposite to the first direction) along the first axis 140. The third section 220 may extend between the corresponding first section 212 and the corresponding second section 216. In an exemplary embodiment, as shown in FIG. 5, the third section 220 (of the first bore 196) includes a tapered seat 224 that converges from the first section 212 to the second section 216 in the first direction along the first axis 140. The third section 220 may be configured to inhibit movement of the pin 124, inserted from the corresponding first section 212, towards the corresponding second section 216. In other embodiments, the third section 220 may include a step seat.

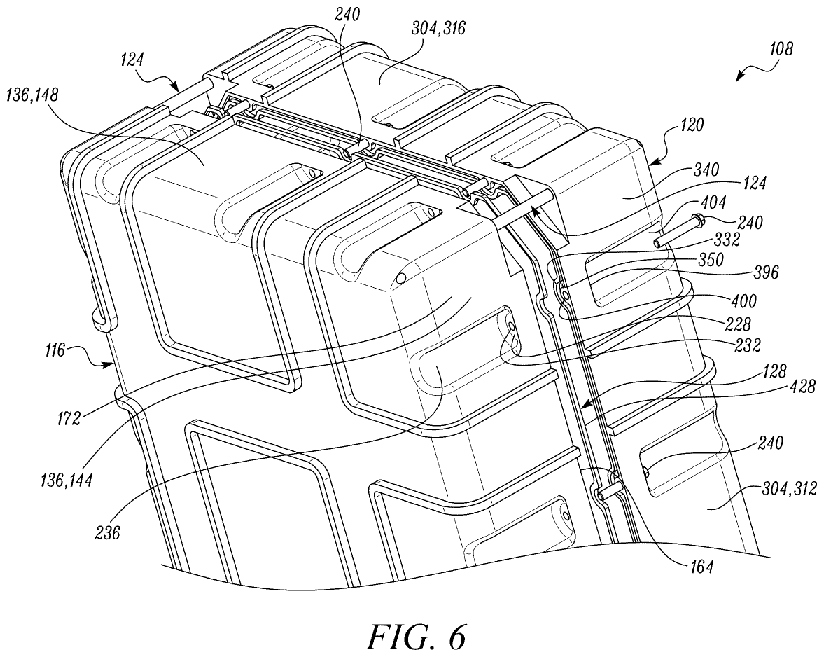

The first casing member 116 may further include multiple first mounting surfaces 228 and corresponding first holes 232. In an example, as shown in FIG. 6, the first casing member 116 includes multiple first indents 236 defined on the external surface 172 (or the external periphery 172) of the first sidewalls 136. Each of the first indents 236 may extend from the first base wall 132 toward the first mating surface 164 along the first axis 140 to correspondingly define the first mounting surfaces 228 between the first base wall 132 and the first mating surface 164. Further, the first holes 232 may extend between the corresponding first mounting surfaces 228 and the first mating surface 164. The first holes 232 may be configured to receive corresponding fastening members 240 to assemble the first casing member 116 with the second casing member 120.

In an exemplary embodiment, as shown in FIGS. 1-6, four first mounting surfaces 228 and corresponding four first holes 232 are defined on the external surface 172 (or the external periphery 172) of each of the first wall 144 and the third wall 152, and three first mounting surfaces 228 and corresponding three first holes 232 are defined on the external surface 172 (or the external periphery 172) of each of the second wall 148 and the fourth wall 156. However, it may be contemplated that, in other embodiments, the first casing member 116 may include a lower or a higher number of the first mounting surfaces 228 and the first holes 232.

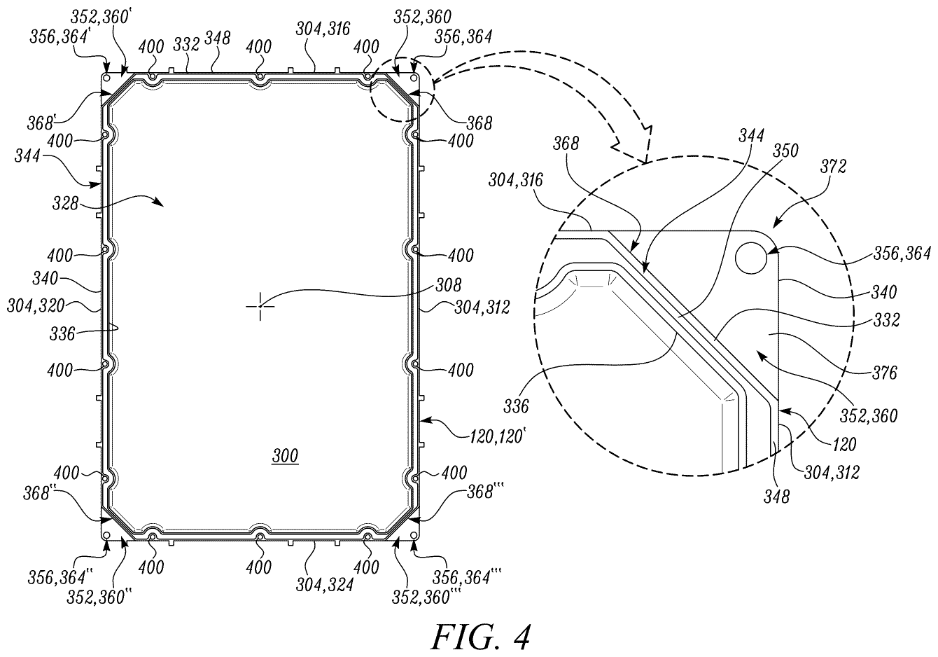

The second casing member 120 will now be discussed with reference to FIGS. 2, 4, 5, and 6. The second casing member 116 defines a second base wall 300 and a plurality of second sidewalls 304 that extend from the second base wall 300 along a second axis 308 of the second casing member 120. By way of non-limiting example, the second casing member 120 may be embodied as a substantially hollow cuboid shaped structure 120′ with one opened wall. In an exemplary embodiment, the second casing member 120 defines four second sidewalls 304, namely—a fifth wall 312, a sixth wall 316, a seventh wall 320, and an eighth wall 324. The fifth wall 312 and the seventh wall 320 may be disposed perpendicular to the second base wall 300. Also, the fifth wall 312 and the seventh wall 320 may be disposed parallel to and spaced apart from each other. Further, the sixth wall 316 and the eighth wall 324 may be disposed parallel to and spaced apart from each other. Also, the sixth wall 316 and the eighth wall 324 may be disposed perpendicular to the second base wall 300, and the fifth wall 312 and the seventh wall 320. The second base wall 300, the fifth wall 312, the sixth wall 316, the seventh wall 320, and the eighth wall 324 combinedly define a second portion 328 (shown in FIG. 4) of the closed volume 112 of the enclosure 108.

The second sidewalls 304 extend outwardly from the second base wall 300, along the second axis 308, to define a second mating surface 332 spaced from the second base wall 300. In an example, as shown in FIG. 4, the second sidewalls 304 define an internal surface 336 (or internal periphery 336) extending around the second portion 328 (of the closed volume 112) and an external surface 340 (or external periphery 340) extending around the internal surface 336 to define the second mating surface 332. The second mating surface 332 may define an annular path 344 (hereinafter referred to as “second annular path 344”) surrounding the second portion 328 (of the closed volume 112), and an end face 348 (hereinafter referred to as “second end face 348”) extending along the second annular path 344. The second end face 348 may be a planar surface. In addition, the second mating surface 332 may define a groove 350 that extend inwardly from the second end face 348 into the second sidewalls 304. The groove 350 may be defined throughout the second annular path 344 of the second mating surface 332. Further, as shown in FIG. 2, multiple rails 354 (similar to the rails 178) are defined at the second base wall 300 and the second sidewalls 304.

Further, the second casing member 120 includes one or more pocket surfaces 352 (hereinafter referred to as “second pocket surface 352”) and corresponding one or more second bores 356. In an exemplary embodiment, as shown in FIG. 4, the second casing member 120 includes four second pocket surfaces 352, namely—the second pocket surfaces 360, 360′, 360″, 360″′, and corresponding four second bores 356, namely—the second bores 364, 364′, 364″, 364″′. It may be contemplated that, in other embodiments, the second casing member 120 may include a lower or a higher number of the pocket surfaces and the second bores.

The second pocket surface 360 may be a planar surface. The second pocket surface 360 may be parallel to the second mating surface 332. In addition, the second pocket surface 360 may be parallel to the second base wall 300. The second pocket surface 360 is defined between the second mating surface 332 and the second base wall 300. In an example, as shown in FIGS. 2 and 4, the second casing member 120 includes a pocket 368 defined in the external surface 340 (or the external periphery 340) of the at least one second sidewall 304, for example, at a junction 372 of two adjacent second sidewalls 304, i.e., the fifth wall 312 and the sixth wall 316. In the present configuration, the pocket 368 extends from the second mating surface 332 towards the second base wall 300 (along the second axis 308) to define a shoulder portion 376 that, in turn, defines the second pocket surface 360. It should be noted that the remaining second pocket surfaces 360′, 360″, 360″′ may be defined in a similar manner, as described above, by their respective pockets 368′, 368″, 368″′, and therefore are not discussed in detail for brevity.

The second bores 364, 364′, 364″, 364″′ may extend between their corresponding second pocket surfaces 360, 360′, 360″, 360″′ and the second base wall 300. For example, the second bore 364 may extend between the second pocket surface 360 and the second base wall 300, the second bore 364′ may extend between the corresponding second pocket surface 360′ and the second base wall 300, the second bore 364″ may extend between the corresponding second pocket surface 360″ and the second base wall 300, and the second bore 364″′ may extend between the corresponding second pocket surface 360″′ and the second base wall 300.

For explanatory purposes, the second bore 364 will now be explained in detail with reference to FIG. 5. However, it should be noted that the description provided below for the second bore 364 may be equally applicable to the other second bores 364′, 364″, 364″′ corresponding to their respective second pocket surfaces 360′, 360″, 360″′, without any limitations.

The second bore 364 may define a first section 380, a second section 384, and a third section 388. The first section 380 may have a third diameter. The third diameter of the first section 380 (of the second bore 364) may be equal to the first diameter of the first section 212 (of the first bore 196). The first section 380 may extend from the corresponding second pocket surface 360 towards the second base wall 300 along the second axis 308. The second section 384 may have a fourth diameter lower than the third diameter of the first section 380. Also, the fourth diameter of the second section 384 may be equal to the second diameter of the second section 216 (of the first bore 196). Further, the second section 384 may extend from the second base wall 300 towards the corresponding second pocket surface 360 along the second axis 308. The third section 388 may extend between the corresponding first section 380 and the corresponding second section 384. In an exemplary embodiment, as shown in FIG. 5, the third section 388 includes a step seat 392 extending substantially perpendicular to the second axis 308 between the first section 380 and the second section 384. The third section 388 may be configured to inhibit movement of the pin 124, inserted from the corresponding first section 380, towards the corresponding second section 384. In other embodiments, the third section 388 may include a tapered seat that may converge from the first section 380 to the second section 384 along the second axis 308.

The second casing member 120 may further include multiple second mounting surfaces 396 and corresponding second holes 400. In an example, as shown in FIG. 6, the second casing member 120 includes multiple second indents 404 defined on the external surface 340 (or the external periphery 340) of the second sidewalls 304. Each of the second indents 404 may extend from the second base wall 300 toward the second mating surface 332 along the second axis 308 to correspondingly define the second mounting surfaces 396 between the second base wall 300 and the second mating surface 332. Further, the second holes 400 may extend between the corresponding second mounting surfaces 396 and the second mating surface 332. The second holes 400 may be configured to receive the corresponding fastening members 240 to assemble the second casing member 120 with the first casing member 116.

In an exemplary embodiment, as shown in FIGS. 2 and 4, four second mounting surfaces 396 and corresponding four second holes 400 are defined on the external surface 340 (or the external periphery 340) of each of the fifth wall 312 and the seventh wall 320, and three second mounting surfaces 396 and corresponding three second holes 400 are defined on the external surface 340 (or the external periphery 340) of each of the sixth wall 316 and the eighth wall 324. However, it may be contemplated that, in other embodiments, the second casing member 120 may include a lower or a higher number of the second mounting surfaces 396 and the second holes 400.

The pins 124 will now be discussed. As shown in FIG. 2, the enclosure 108 has four pins 124, namely—pins 408, 408′, 408″, 408″′. The pins 408, 408′, 408″, 408″′ may facilitate alignment and engagement of the first mating surface 164 (of the first casing member 116) with the second mating surface 332 (of the second casing member 120) to define the closed volume 112 of the battery system 100 when the first casing member 116 and the second casing member 120 are assembled together. To this end, the pin 408 is configured to be slidably received within the corresponding first bore 196 and the second bore 364, the pin 408′ is configured to be slidably received within the corresponding first bore 196′ and the second bore 364′, the pin 408″ is configured to be slidably received within the corresponding first bore 196″ and the second bore 364″, and the pin 408″′ is configured to be slidably received within the corresponding first bore 196″′ and the second bore 364″′.

The pin 408 may include a cylindrical body 412, as shown in FIGS. 2 and 5. The cylindrical body 412 may extend longitudinally along a pin axis 416. The cylindrical body 412 may define a first end portion 420 and a second end portion 424 spart from the first end portion 420 along the pin axis 416. Further, the cylindrical body 412 has a diameter equal to or less than the first diameter of the first section 212 (of the first bore 196) and the third diameter of the first section 380 (of the second bore 364).

It should be noted that the description provided above for the pin 408 may be equally applicable to the other pins 408′, 408″, 408″′, without any limitations, and therefore, the other pins 408′, 408″, 408″′ are not discussed in detail for brevity.

The sealing member 128 will now be discussed with reference to FIGS. 2 and 6. The sealing member 128 may include a closed body 428. According to an exemplary embodiment, the term “closed body” may refer to an annular body with a continuous structure (such as, a toroid). For example, the letter “O” is a closed body. It should be noted that the term “annular” is not restricted to circular or toroidal shape, but may also include any non-circular shape such as rectangular, triangular, etc. In the present embodiment, the sealing member 128 has a closed rectangular body 428 with a shape generally following the shape of the groove 350 defined throughout the second annular path 344 of the second mating surface 332 (of the second casing member 120).

In an exemplary assembly of the first casing member 116 and the second casing member 120, the sealing member 128 may be disposed at the first mating surface 164 (of the first casing member 116) and received within the groove 350 defined at the second mating surface 332 (of the second casing member 120) to facilitate a sealable engagement between the first mating surface 164 and the second mating surface 332.

Although four first pocket surfaces 192, 192′, 192″, 192″′ and four second pocket surfaces 360, 360′, 360″, 360″′ are defined at the first casing member 116 and the second casing member 120, respectively, (as illustrated in FIGS. 1-6) it should be noted that, in other embodiments, only one of the first casing member 116 and the second casing member 120 may have such pocket surfaces while the other may be devoid of any such pocket surfaces.

### INDUSTRIAL APPLICABILITY

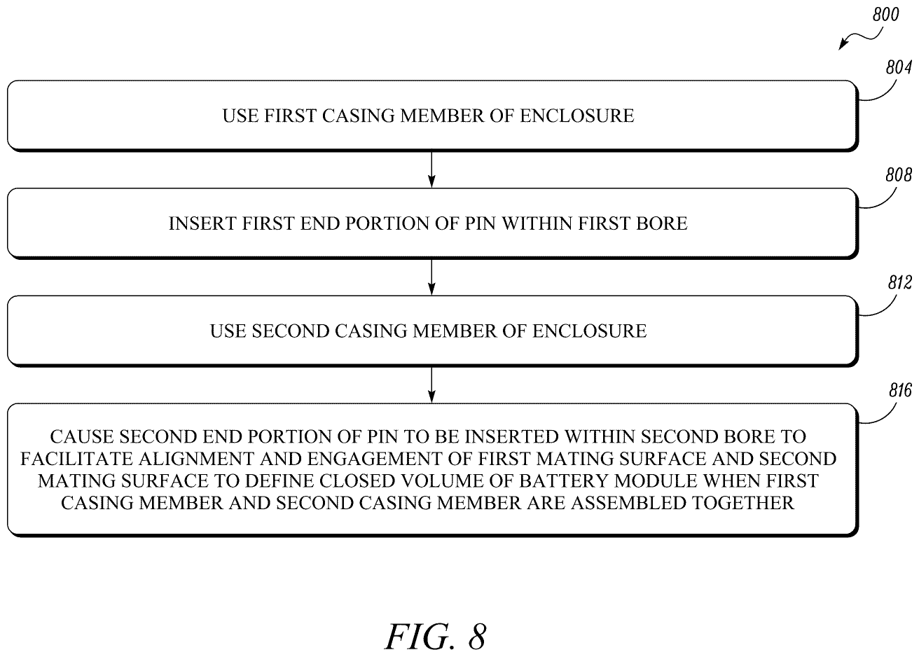

Referring to FIG. 8, an exemplary method of assembling the enclosure 108 of the battery system 100 is discussed. The method is discussed by way of a flowchart 800 that illustrates exemplary steps (i.e., from 804 to 816) associated with the method. The method is also discussed in conjunction with FIGS. 1-7.

The method includes using the first casing member 116 of the enclosure 108 (step 804). The first casing member 116 provides the first portion 160 of the closed volume 112 (of the enclosure 108) to receive the energy storage cells 104. In an example, the energy storage cells 104 may be disposed side-by-side in a row or a column (i.e., collectively referred to as a stack) within the first portion 160 of the closed volume 112 (of the first casing member 116).

Further, the method includes inserting the first end portion 420 of the pin 124 (i.e., the pin 408) within the corresponding first bore 188, i.e., the first bore 196 (step 808). The pin 408 may be inserted within the first bore 196 until the first end portion 420 of the pin 408 may be seated against the third section 220 (e.g., the tapered seat 224) of the first bore 196. At this stage, a portion of the pin 124 may remain (or extend) outwardly from the first bore 196. The remaining pins 408′, 408″, 408″′ may be inserted within their corresponding first bores 196′, 196″, 196″′, in a similar manner as discussed above.

The method further includes using the second casing member 120 of the enclosure 108 (step 812). The second casing member 120 provides the second portion 328 of the closed volume 112 of the enclosure 108. The second casing member 120 is to be assembled with the first casing member 116 in a manner such that the second portion 328 (of the second casing member 120) and the first portion 160 (of the first casing member 116) combinedly define the closed volume 112 of the enclosure 108. To this end, the method includes causing the second end portion 424 of the pin 124 (e.g., the pin 408) to be inserted within the corresponding second bore 364 to facilitate alignment and engagement of the first mating surface 164 (of the first casing member 116) and the second mating surface 332 (of the second casing member 120) to define the closed volume 112 (of the battery system 100) (step 816).

For instance, the second casing member 120 may be positioned relative to the first casing member 116 such that the second mating surface 332 and the first mating surface 164 may face toward each other. At this stage, the sealing member 128 may be disposed at the first mating surface 164 (or in a space between the first mating surface 164 and the second mating surface 332). Next, the pin 408 is inserted with the corresponding second bore 364 and is slidably moved within the second bore 364. The remaining pins 408′, 408″, 408″′ may be inserted within their corresponding second bores 364′, 364″, 364″′, in a similar manner as discussed above.

The pins 408, 408′, 408″, 408″′ may move within their corresponding second bores 364, 364′, 364″, 364″ ′until the first mating surface 164 and the second mating surface 332 abut against each other to form the closed volume 112 of the enclosure 108. In the present configuration, as the first mating surface 164 and the second mating surface 332 abut against each other, the second end portion (such as the second end portion 424) of the pins 408, 408′, 408″, 408″′ may also reach and sit against the third sections (such as the third section 388) of the corresponding second bores 364, 364′, 364″, 364″′. Further, at this stage, the sealing member 128 may be received within the groove 350 (defined at the second mating surface 332) to form the sealable engagement between the first mating surface 164 and the second mating surface 332.

Additionally, in the assembly of the first casing member 116 with the second casing member 120, once the first mating surface 164 and the second mating surface 332 are abutted against one another, the fastening members 240 may be inserted through the corresponding first holes 232 (of the first casing member 116) and the corresponding second holes 400 (of the second casing member 120) to secure the first casing member 116 with the second casing member 120.

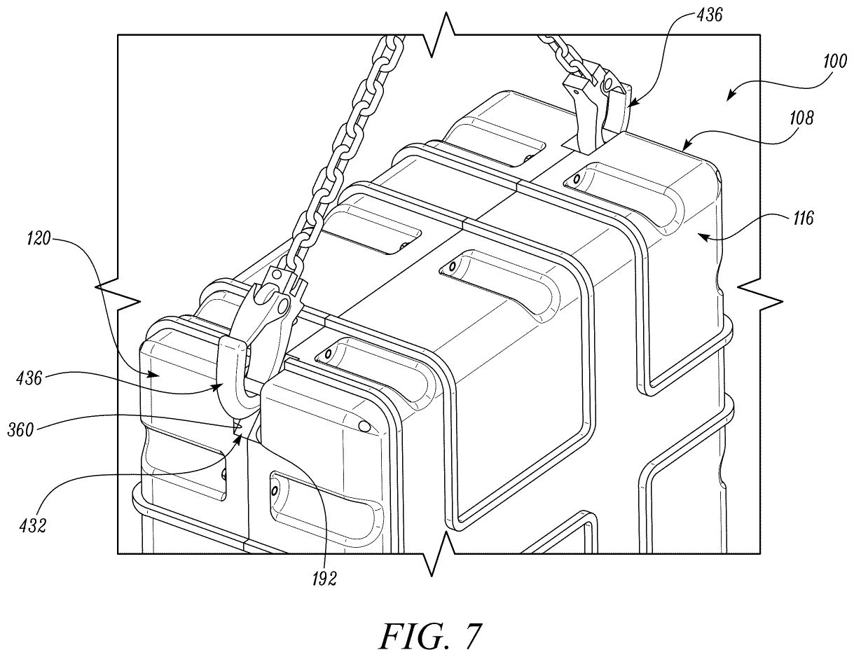

The first casing member 116 and the second casing member 120 are assembled and secured together such that a gap 432 is defined between each of the first pocket surfaces 192, 192′,192″, 192″′ (of the first casing member 116) and the corresponding second pocket surfaces 360, 360′, 360″, 360″′ (of the second casing member 120). Accordingly, the first pocket surfaces 192, 192′,192″, 192″′ (of the first casing member 116) and the second pocket surfaces 360, 360′, 360″, 360″′ (of the second casing member 120) provide access to the portion of the corresponding pins 408, 408′, 408″, 408″′ extending through the corresponding gap 432. By providing access to the portion of the pins 408, 408′, 408″, 408″′, the first pocket surfaces 192, 192′,192″, 192″′ (of the first casing member 116) and the second pocket surfaces 360, 360′, 360″, 360″′ (of the second casing member 120) may facilitate connection of lifting mechanisms, for example, a lifting hook mechanisms 436 (as shown in FIG. 7), with the corresponding pins 408, 408′, 408″, 408″′. Once connected with the lifting mechanisms 436, the enclosure 108 (or the battery system 100) may be lifted and moved between different locations or orientations.

In another embodiment in which only one of the first casing member 116 and the second casing member 120 has the pocket surfaces, for example, only the first casing member 116 has the first pocket surfaces 192, 192′,192″, 192″′ and the second casing member 120 has no pocket surfaces, gaps may be defined between the first pocket surfaces 192, 192′,192″, 192″′ and the second mating surface 332, as the first casing member 116 and the second casing member 120 are assembled together. Such gaps may also provide access to the portion of the corresponding pins 408, 408′, 408″, 408″′ extending between the first pocket surfaces 192, 192′,192″, 192″′ and the second mating surface 332.

Alignment and engagement of the first mating surface 164 (of the first casing member 116) with the second mating surface 332 (of the second casing member 120), by inserting the pins 124 within their corresponding first bores 188 (defined at the first pocket surfaces 184) and the corresponding second bores 356 (defined at the second pocket surfaces 352), as discussed above, may provide accurate and adequate sealing connection between the first casing member 116 and the second casing member 120. Further, as the first casing member 116 and the second casing member 120 are assembled together, the first pocket surfaces 184 (defined at the first casing member 116) and the second pocket surfaces 352 (defined at the second casing member 120) may provide access to the portion of the pins 124 extending within the gap (such as the gap 432) extending between each of the first pocket surfaces 184 and the corresponding second pocket surfaces 352. This may facilitate connection of the lifting mechanisms with the pins 124, thereby enabling the lifting and movement of the enclosure 108 (or the battery system 100) between different locations or orientations, such as during installation or removal of the enclosure 108 from the machine for servicing. In addition, providing the first pocket surfaces 184 and the second pocket surfaces 352 at the first casing member 116 and the second casing member 120, respectively, may eliminate the requirement of conventional built-in lifting provisions (that may require material and/or external features) to be added to the battery system enclosure, thereby limiting the overall footprint of the battery system enclosure to the actual dimensions of the battery system enclosure.

Unless explicitly excluded, the use of the singular to describe a component, structure, or operation does not exclude the use of plural such components, structures, or operations or their equivalents. The use of the terms “a” and “an” and “the” and “at least one” or the term “one or more,” and similar referents in the context of describing the invention (especially in the context of the following claims) are to be construed to cover both the singular and the plural, unless otherwise indicated herein or clearly contradicted by context. The use of the term “at least one” followed by a list of one or more items (for example, “at least one of A and B” or one or more of A and B”) is to be construed to mean one item selected from the listed items (A or B) or any combination of two or more of the listed items (A and B; A, A and B; A, B and B), unless otherwise indicated herein or clearly contradicted by context. Similarly, as used herein, the word “or” refers to any possible permutation of a set of items. For example, the phrase “A, B, or C” refers to at least one of A, B, C, or any combination thereof, such as any of: A; B; C; A and B; A and C; B and C; A, B, and C; or multiple of any item such as A and A; B, B, and C; A, A, B, C, and C; etc.

It will be apparent to those skilled in the art that various modifications and variations can be made to the enclosure, the battery system, and/or the method of the present disclosure without departing from the scope of the disclosure. Other embodiments will be apparent to those skilled in the art from consideration of the specification and practice of the enclosure, the battery system, and/or the method disclosed herein. It is intended that the specification and examples be considered as exemplary only, with a true scope of the disclosure being indicated by the following claims and their equivalent.

What is claimed is:

1. An enclosure for a battery system, the enclosure comprising:
a first casing member defining a first base wall and a plurality of first sidewalls extending from the first base wall along a first axis to define a first mating surface spaced from the first base wall, the first casing member including:
a pocket surface defined between the first mating surface and the first base wall; and
a first bore extending between the pocket surface and the first base wall along the first axis;
a second casing member defining a second base wall and a plurality of second sidewalls extending from the second base wall along a second axis to define a second mating surface spaced from the second base wall, the second casing member including a second bore; and
a pin slidably received within the first bore and the second bore, the pin configured to facilitate alignment and engagement of the first mating surface with the second mating surface to define a closed volume of the battery system when the first casing member and the second casing member are assembled together,
wherein, when the first casing member and the second casing member are assembled together, the pocket surface provides access to a portion of the pin extending between the pocket surface and the second mating surface.

2. The enclosure of claim 1, wherein the pocket surface is a first pocket surface, the second casing member including a second pocket surface defined between the second mating surface and the second base wall, wherein the second bore extends between the second pocket surface and the second base wall along the second axis, and
wherein, when the first casing member and the second casing member are assembled together, the first pocket surface and the second pocket surface provides access to a portion of the pin extending between the first pocket surface and the second pocket surface.

3. The enclosure of claim 1, wherein the first casing member includes a pocket defined in an external surface of at least one first sidewall of the plurality of first sidewalls, the pocket extending from the first mating surface towards the first base wall to define a shoulder portion, and wherein the pocket surface is defined by the shoulder portion.

4. The enclosure of claim 3, wherein the pocket is located at a junction of two adjacent first sidewalls of the plurality of first sidewalls.

5. The enclosure of claim 2, wherein each of the first bore and the second bore defines:
a first section extending from the corresponding first and second pocket surfaces towards the corresponding first and second base walls along the corresponding first and second axes,
a second section extending from the corresponding first and second base walls towards the corresponding first and second pocket surfaces along the corresponding first and second axes, and
a third section extending between the corresponding first and second sections, the third section is configured to inhibit movement of the pin from the corresponding first section towards the corresponding second section.

6. The enclosure of claim 5, wherein the third section includes one of a flat seat and a tapered seat.

7. The enclosure of claim 1, wherein the second mating surface defines an end face and a groove extending inwardly from the end face into the plurality of second sidewalls, the groove is defined throughout an annular path defined by the second mating surface, the enclosure including:
a sealing member disposed at the first mating surface and configured to be received within the groove to facilitate a sealable engagement between the first mating surface and the second mating surface, when the first casing member and the second casing member are assembled together.

8. The enclosure of claim 1, wherein
the first casing member includes a plurality of first mounting surfaces defined in an external surface of the plurality of first sidewalls, and a plurality of first holes extending between the corresponding plurality of first mounting surfaces and the first mating surface, and
the second casing member includes a plurality of second mounting surfaces defined in an external surface of the plurality of second sidewalls, and a plurality of second holes extending between the corresponding plurality of second mounting surfaces and the second mating surface, and
wherein, when the first casing member and the second casing member are assembled together, the plurality of first holes and the plurality of second holes receive a corresponding plurality of fastening members to secure the first casing member with the second casing member.

9. A battery system, comprising:
one or more energy storage cells; and
an enclosure for accommodating the one or more energy storage cells, the enclosure including:
a first casing member defining a first base wall and a plurality of first sidewalls extending from the first base wall along a first axis to define a first mating surface spaced from the first base wall, the first casing member including:
a pocket surface defined between the first mating surface and the first base wall; and
a first bore extending between the pocket surface and the first base wall along the first axis;
a second casing member defining a second base wall and a plurality of second sidewalls extending from the second base wall along a second axis to define a second mating surface spaced from the second base wall, the second casing member including a second bore; and
a pin slidably received within the first bore and the second bore, the pin configured to facilitate alignment and engagement of the first mating surface with the second mating surface to define a closed volume of the battery system when the first casing member and the second casing member are assembled together,
wherein, when the first casing member and the second casing member are assembled together, the pocket surface provides access to a portion of the pin extending between the pocket surface and the second mating surface.

10. The battery system of claim 9, wherein the pocket surface is a first pocket surface, the second casing member including a second pocket surface defined between the second mating surface and the second base wall, wherein the second bore extends between the second pocket surface and the second base wall along the second axis, and
wherein, when the first casing member and the second casing member are assembled together, the first pocket surface and the second pocket surface provides access to a portion of the pin extending between the first pocket surface and the second pocket surface.

11. The battery system of claim 9, wherein the first casing member includes a pocket defined in an external surface of at least one first sidewall of the plurality of first sidewalls, the pocket extending from the first mating surface towards the first base wall to define a shoulder portion, and wherein the pocket surface is defined by the shoulder portion.

12. The battery system of claim 11, wherein the pocket is located at a junction of two adjacent first sidewalls of the plurality of first sidewalls.

13. The battery system of claim 10, wherein each of the first bore and the second bore defines:
a first section extending from the corresponding first and second pocket surfaces towards the corresponding first and second base walls along the corresponding first and second axes,
a second section extending from the corresponding first and second base walls towards the corresponding first and second pocket surfaces along the corresponding first and second axes, and
a third section extending between the corresponding first and second sections, the third section is configured to inhibit movement of the pin from the corresponding first section towards the corresponding second section, wherein the third section includes one of a flat seat and a tapered seat.

14. The battery system of claim 9, wherein the second mating surface defines an end face and a groove extending inwardly from the end face into the plurality of second sidewalls, the groove is defined throughout an annular path defined by the second mating surface, the enclosure including:
a sealing member disposed at the first mating surface and configured to be received within the groove to facilitate a sealable engagement between the first mating surface and the second mating surface, when the first casing member and the second casing member are assembled together.

15. The battery system of claim 9, wherein
the first casing member includes a plurality of first mounting surfaces defined in an external surface of the plurality of first sidewalls, and a plurality of first holes extending between the corresponding plurality of first mounting surfaces and the first mating surface, and
the second casing member includes a plurality of second mounting surfaces defined in an external surface of the plurality of second sidewalls, and a plurality of second holes extending between the corresponding plurality of second mounting surfaces and the second mating surface, and
wherein, when the first casing member and the second casing member are assembled together, the plurality of first holes and the plurality of second holes receive a corresponding plurality of fastening members to secure the first casing member with the second casing member.

16. A method of assembling an enclosure of a battery system, the method comprising:
using a first casing member of the enclosure, the first casing member defining a first base wall and a plurality of first sidewalls extending from the first base wall along a first axis to define a first mating surface spaced from the first base wall, the first casing member including a pocket surface defined between the first mating surface and the first base wall and a first bore extending between the pocket surface and the first base wall;
inserting a first end portion of a pin within the first bore;
using a second casing member of the enclosure, the second casing member defining a second base wall and a plurality of second sidewalls extending from the second base wall along a second axis to define a second mating surface spaced from the second base wall, the second casing member including a second bore; and
causing a second end portion of the pin to be inserted within the second bore to facilitate alignment and engagement of the first mating surface and the second mating surface to define a closed volume of the battery system when the first casing member and the second casing member are assembled together,
wherein, when the first casing member and the second casing member are assembled together, the pocket surface provides access to a portion of the pin extending between the pocket surface and the second mating surface.

17. The method of claim 16, wherein the first casing member includes a plurality of first mounting surfaces and a plurality of first holes extending between the corresponding plurality of first mounting surfaces and the first mating surface, and the second casing member includes a plurality of second mounting surfaces and a plurality of second holes extending between the corresponding plurality of second mounting surfaces and the second mating surface, the method including:
inserting a plurality of fastening members through the corresponding plurality of first holes and the corresponding plurality of second holes to secure the first casing member with the second casing member, when the first casing member and the second casing member are assembled together.

18. The method of claim 16, wherein the pocket surface is a first pocket surface, the second casing member including a second pocket surface defined between the second mating surface and the second base wall, wherein the second bore extends between the second pocket surface and the second base wall along the second axis, and
wherein, when the first casing member and the second casing member are assembled together, the first pocket surface and the second pocket surface provides access to a portion of the pin extending between the first pocket surface and the second pocket surface.

19. The method of claim 16, wherein the first casing member includes a pocket defined in an external surface of at least one first sidewall of the plurality of first sidewalls, the pocket extending from the first mating surface towards the first base wall to define a shoulder portion,
wherein the pocket surface is defined by the shoulder portion, and
wherein the pocket is located at a junction of two adjacent first sidewalls of the plurality of first sidewalls.

20. The method of claim 18, wherein each of the first bore and the second bore defines:
a first section extending from the corresponding first and second pocket surfaces towards the corresponding first and second base walls along the corresponding first and second axes,
a second section extending from the corresponding first and second base walls towards the corresponding first and second pocket surfaces along the corresponding first and second axes, and
a third section extending between the corresponding first and second sections, the third section is configured to inhibit movement of the pin from the corresponding first section towards the corresponding second section, wherein the third section includes one of a flat seat and a tapered seat.
